(19) United States
(12) Patent Application Publication
(10) Pub. No.: US 2026/0058130 A1
(43) Pub. Date: Feb. 26, 2026

(54) Cathode Mixture

(71) Applicant: TOYOTA JIDOSHA KABUSHIKI KAISHA, Toyota-shi, Aichi-ken (JP)

(72) Inventor: Hideaki WATANABE, Nisshin-shi, Aichi-ken (JP)

(73) Assignee: TOYOTA JIDOSHA KABUSHIKI KAISHA, Toyota-shi, Aichi-ken (JP)

(21) Appl. No.: 18/929,805

(22) Filed: Oct. 29, 2024

(30) Foreign Application Priority Data
Nov. 8, 2023 (JP) 2023-189437

(51) Int. Cl. H01M 4/36; H01M 4/02; H01M 4/525; H01M 10/0562

(52) U.S. Cl. CPC H01M 4/366; H01M 4/525; H01M 10/0562; H01M 2004/021; H01M 2004/028; H01M 2300/0071; H01M 2300/0094

(57) ABSTRACT

A main object of the present disclosure isa to provide a cathode mixture capable of achieving good battery energy-density and suppressing increased battery resistivity when used in battery. The present disclosure achieves the object by providing a cathode mixture comprising a composite cathode active material including a cathode active material, a first sulfide solid electrolyte and an oxide solid electrolyte, a second sulfide solid electrolyte and a fluorine-based lubricant, wherein the composite cathode active material includes a coating layer covering at least a portion of a surface of the cathode active material and including the first sulfide solid electrolyte and the oxide solid electrolyte; the coating layer includes a first coating layer including the first sulfide solid electrolyte, and a second coating layer arranged between the cathode active material and the first coating layer and including the oxide solid electrolyte; the second sulfide solid electrolyte is not included in the coating layer; and when the sum of a volume of the cathode active material and the second coating layer is X and the sum of a volume of the first coating layer and the second sulfide solid electrolyte is Y, a ratio of the X to the sum of the X and the Y (X/(X+Y)) is 72% by volume or more and 78% by volume or less.

### TECHNICAL FIELD

The present disclosure relates to a cathode mixture.

### BACKGROUND ART

With the rapid spread of information-related devices such as personal computers, video cameras, and mobile phones, and communication devices in recent years, the importance of developing a battery that is used as a power source thereof has been emphasized. The automotive industry is also developing high-power and high-capacity battery for battery electric vehicle or hybrid-type automobiles.

In addition, for the purpose of enhancing battery performance, a battery material has been studied. For example, Patent Literature 1 discloses a composite cathode active material including a composite particle including active material particles and an oxide solid electrolyte that covers a portion of the active material particle surface, and a sulfide based solid electrolyte that covers a portion of the composite particle surface.

In addition, Patent Literature 2 discloses a cylindrical nonaqueous electrolyte secondary battery in which lubricating layers containing a fluororesin are provided.

### CITATION LIST

### Patent Literatures

Patent Literature 1: Japanese Patent Application Laid-Open (JP-A) No. 2014-154406
Patent Literature 2: JP-A 2010-049909

### SUMMARY OF DISCLOSURE

### Technical Problem

From the viewpoint of improving the performance of battery, a battery with good energy-density and reduced an increase of resistance has been demanded. The present disclosure has been made in view of the above circumstances, and it is a main object of the present disclosure to provide a cathode mixture capable of achieving good battery energy-density and suppressing increased battery resistivity when used in battery.

### Solution to Problem

[1]

A cathode mixture comprising a composite cathode active material including a cathode active material, a first sulfide solid electrolyte and an oxide solid electrolyte, a second sulfide solid electrolyte and a fluorine-based lubricant, wherein
the composite cathode active material includes a coating layer covering at least a portion of a surface of the cathode active material and including the first sulfide solid electrolyte and the oxide solid electrolyte;
the coating layer includes a first coating layer including the first sulfide solid electrolyte, and a second coating layer arranged between the cathode active material and the first coating layer and including the oxide solid electrolyte;
the second sulfide solid electrolyte is not included in the coating layer; and
when the sum of a volume of the cathode active material and the second coating layer is X and the sum of a volume of the first coating layer and the second sulfide solid electrolyte is Y, a ratio of the X to the sum of the X and the Y (X/(X+Y)) is 72% by volume or more and 78% by volume or less.
   [2]

The cathode mixture according to [1], wherein the fluorine-based lubricant is a perfluoropolyether.

[3]

The cathode mixture according to [1] or [2], wherein a ratio of the fluorine-based lubricant to cathode active material is 0.4 wt % or more and 1.2 wt % or less.

[4]

The cathode mixture according to any one of [1] to [3], wherein a ratio of the fluorine-based lubricant to cathode active material is 0.4 wt % or more and 1.2 wt % or less.

[5]

The cathode mixture according to any one of [1] to [4], wherein a total thickness of the first coating layer and the second coating layer is 100 μm or less.

### Advantageous Effects of Disclosure

According to the present disclosure, it is possible to provide a cathode mixture capable of achieving good battery energy-density and suppressing battery resistivity from increasing.

### BRIEF DESCRIPTION OF DRAWINGS

FIGS. 1A and 1B are diagrams for explaining a mechanism that the cathode mixture in the present disclosure can solve the problem.

FIG. 2 is a schematic cross-sectional view illustrating a composite cathode active material in the present disclosure.

### DESCRIPTION OF THE EMBODIMENTS

Hereinafter, cathode mixture according to the present disclosure will be described in detail.

Cathode mixture includes a composite cathode active material including a cathode active material, a first sulfide solid electrolyte, and an oxide solid electrolyte, a second sulfide solid electrolyte, and a fluorine-based lubricant. The composite cathode active material includes a coating layer that covers at least a part of the surface of cathode active material and includes the first sulfide solid electrolyte and the oxide solid electrolyte. Further, in cathode mixture according to the present disclosure, when the volume of the sum of cathode active material and the second coating layer is X and the volume of the sum of the first coating layer and the second sulfide solid electrolyte is Y, the ratio (X/(X+Y)) of the X to the sum of the X and the Y is 72% by volume or more and 78% by volume or less.

According to the present disclosure, since cathode mixture contains the composite cathode active material, the second sulfide solid electrolyte, and the fluorine-based lubricant, and the ratio of X to the sum of the predetermined volume X and the volume Y is within a predetermined range, cathode mixture is capable of improving the energy-density of battery and suppressing an increase in battery resistivity when used in battery.

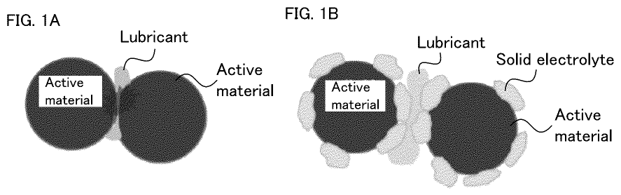

A mechanism by which cathode mixture can solve the problem will be described with reference to FIG. 1. First, in order to increase the energy-density of battery, it is assumed that the volume fraction of cathode active material in cathode mixture is increased. On the other hand, if the ratio of cathode active material is too high, it is difficult to increase the packing ratio, and there is room for improvement in energy-density. In this regard, as shown in FIG. 1A, the present inventors first assumed that a fluorine-based lubricant is added to cathode mixture in order to suppress adhesive between active materials and increase the packing ratio. On the other hand, when cathode active material and the fluorine-based lubricant are in direct contact with each other, a strong frictional force may be applied to the fluorine-based lubricant due to a press or the like at the time of forming cathode active material layers. When the fluorine-based lubricant is decomposed by the frictional force, corrosive gases such as CF₂O may be generated. When such gases react with the active material, battery resistance may be increased, such as an increase in the reaction resistance, and battery may be deteriorated.

On the other hand, as shown in FIG. 1B, the inventors have found that, by arranging solid electrolyte between cathode active material, solid electrolyte can function as a buffer layer, and decomposition of the fluorine-based lubricant can be suppressed. However, simply adjusting the position of solid electrolyte and using a fluorine-based lubricant may not suppress battery resistivity. In view of the above, the present inventors have studied intensively and found that both the energy-density of coating layer and the suppression of the increase of cathode active material resistivity can be achieved by setting the volume ratio of the oxide solid electrolyte (second battery) coated cathode active material with the first sulfide solid electrolyte (first coating layer) and the second coating layer coated sulfide solid electrolyte (second coating layer) in the first OOI and the mixture as the buffer layers, thereby completing the present disclosure.

In cathode mixture disclosed herein, the volume of the sum of cathode active material and the second coating layer is X, and the volume of the sum of the first coating layer and the second sulfide solid electrolyte is Y. In this case, the ratio (X/(X+Y)) of the X to the total of the X and the Y is 72% by volume or more and 78% by volume or less. The ratio may be 73% by volume or more, 74% by volume or more, or 75% by volume or more. On the other hand, the ratio may be 77% by volume or less, or 76% by volume or less. The ratio of the volume can be determined by microscopic observation such as scanning electron microscope (Scanning Electron Microscope: SEM), for example. In the case where the ratio is calculated for Y, that is, the ratio of Y to the total of X and Y (Y/(X+Y)) is 22% by volume or more and 28% by volume or less.

The components of the composite cathode active material and the second sulfide solid electrolyte will be described later.

### 1. Composite Cathode Active Material

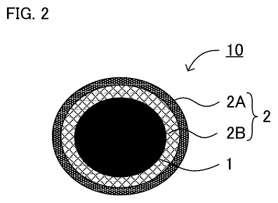

FIG. 2 is a schematic cross-sectional view illustrating a composite cathode active material according to the present disclosure. As shown in FIG. 2, the composite cathode active material 10 includes a cathode active material 1 and a coating layer 2 covering at least a part of the surface of cathode active material 1 and including a first sulfide solid electrolyte and an oxide solid electrolyte. Coating layer 2 includes a first coating layer 2A including a first sulfide solid electrolyte, and a second coating layer 2B disposed between cathode active material 1 and the first coating layer 2A and including the oxide solid electrolyte.

### (1) Cathode Active Material

The type of cathode active material is not particularly limited. Examples of the cathode active material may include an oxide active material. Examples of the oxide active material include rock salt layered active materials such as LiCoO₂, LiMnO₂, LiNiO₂, LiVO₂, LiNi_{1/3}CO_{1/3}Mn_{1/3}O₂ and LiNi_{0.8}CO_{0.15}Al_{0.05}O₂, spinel-type active materials such as LiMn₂O₄, Li₄Ti₅O₁₂, Li(Ni_{0.5}Mn_{1.5})O₄, and olivine-type active materials such as LiFePO₄, LiMnPO₄, LiNiPO₄, LiCoPO₄.

The form of cathode active material is, for example, particulate. Average particle size (D₅₀) of cathode active material is not particularly limited, but is, for example, not less than 10 nm and not more than 50 micrometers.

### (2) Coating Layer

Coating layer covers at least a part of cathode active material and contains a first sulfide solid electrolyte and an oxide solid electrolyte. Coating layer includes a first coating layer including a first sulfide solid electrolyte, and a second coating layer disposed between cathode active material and the first solid electrolyte and including the oxide OOE.

### (i) First Coating Layer

The first coating layer contains a first sulfide solid electrolyte. In the composite cathode active material, the first coating layer may be regarded as a layer that contains the first sulfide solid electrolyte and covers the second coating layer. The first coating layer may cover all or part of the second coating layer. The first coating layer may have a portion in direct contact with cathode active material (a portion that directly covers cathode active material).

Examples of the sulfide solid electrolyte may include a solid electrolyte containing a Li element, an X element (X is at least one kind of P, As, Sb, Si, Ge, Sn, B, Al, Ga, and In), and a S element. Also, the sulfide solid electrolyte may further include at least one of an O element and a halogen element. Examples of the halogen element may include F element, Cl element, Br element, and I element. Sulfide solid electrolyte may be glass (amorphous) or glass ceramic. Sulfide solid electrolyte include, for example, Li₂S—P₂S₅, LiI—Li₂S—P₂S₅, LiI—LiBr—Li₂S—P₂S₅, Li₂S—SiS₂, Li₂S—GeS₂ and Li₂S—P₂S₅—GeS₂.

Average particle size (D₅₀) of the first sulfide solid electrolyte is, for example, 0.1 μm or more and 100 μm or less. Average particle size (D₅₀) refers to the cumulative 50% particle size in a volume-based particle size distribution by a laser diffractive particle size distribution analyzer.

Here, when the volume of the first coating layer is Z, the ratio (Z/X) of Z to X is, for example, 5% by volume or more, may be 8% by volume or more, may be 10% by volume or more, or may be 12% by volume or more. On the other hand, the ratio may be, for example, 20% by volume or less, 18% by volume or less, or 16% by volume or less. Since Z is part of Y (the sum of the volume of the first coating layer and the volume of the second sulfide solid electrolyte) above, if Z/X is too high, the volume of the second sulfide solid electrolyte may be relatively reduced, and a satisfactory fill factor may not be obtained.

The thickness (average thickness) of the first coating layer may be the same as or different from the average thickness of the second coating layer described later. The thickness of the first coating layer is, for example, 1 μm or more and 90 μm or less.

### (ii) Second Coating Layer

The second coating layer contains an oxide solid electrolyte. The second coating layer is disposed between cathode active material and the first coating layer. The second coating layer contains an oxide solid electrolyte and can be regarded as a layer which is in direct contact with cathode active material (a layer which directly covers cathode active material). The second coating layer may cover all or part of cathode active material.

Examples of the oxide solid electrolyte include a Li₇La₃Zr₂O₁₂, Li₇₋ₓLa₃ (Zr₂₋ₓNbₓ)O₁₂ (0≤x≤2), Li₅La₃Nb₂O₁₂ type solid electrolyte such as Li—P—O; a perovskite type solid electrolyte such as (Li, La) TiO₃, (Li, La) NbO₃, (Li, Sr) (Ta, Zr) O₃; a Li—B—O type solid electrolyte such as Li(Al, Ti(PO₄)₃, Li(Al, Ga) (PO₄)₃ pear type solid electrolyte; a compound in which a part of O of Li₃PO₄, LIPON (Li₃PO₄ is substituted with N); and a compound in which a part of O of Li₃BO₃, Li₃BO₃ is substituted with C.

Average particle size (D₅₀) of the oxide solid electrolyte is, for example, 0.1 μm or more and 100 μm or less. The thickness (mean thickness) of the second coating layer is, for example, 1 μm or more and 90 μm or less.

(iii) Coating Layer

The coverage by coating layer is not particularly limited, but may be, for example, 50% or more, 60% or more, or 70% or more. On the other hand, the coverage may be 100% or less, 99% or less, 90% or less, or 80% or less.

Coating layer depth (the sum of the depth of the first coating layer and the second coating layer) is not particularly limited, for example 1μ or more, may be 5μ or more, may be 10μ or more, it may be 50μ or more. On the other hand, the thickness of coating layer is, for example, 100 μm or less, may be 80 μm or less, or may be 60 μm or less.

### (3) Composite Cathode Active Material

Examples of the form of the composite cathode active material include particulate. Average particle size (D₅₀) of the composite cathode active material is, for example, 3 μm or more, and may be 10 μm or more. On the other hand, average particle size of the composite cathode active material is, for example, 150 μm or less, and may be 100 μm or less.

### 2. Second Sulfide Solid Electrolyte

Cathode mixture contains a second sulfide solid electrolyte. The second sulfide solid electrolyte is a cathode mixture that is not included in the above-described coating layer.

As for the second sulfide solid electrolyte, the same sulfide solid electrolyte as the above-described first sulfide solid electrolyte can be cited. The second sulfide solid-state electrified electrolyte may be the same solid electrolyte as the first sulfide solid electrolyte or may be a distinct solid electrolyte.

The shapes of the second sulfide solid electrolyte and average particle size are the same as those of the first sulfide solid electrolyte.

The ratio of the second sulfide solid electrolyte in cathode mixture is not particularly limited as long as X/(X+Y) is the above-described amount. The ratio of the volume of the second sulfide solid electrolyte to the sum of the volume of the composite cathode active material and the volume of the second sulfide solid electrolyte is, for example, 10% by volume or more and 20% by volume or less.

### 3. Fluorinated Lubricant

Cathode mixture contains a fluorine-based lubricant.

The type of the fluorine-based lubricant is not particularly limited, and examples thereof include perfluoropolyether, chlorotrifluoroethylene, and polytetrafluoroethylene.

In cathode mixture, the ratio of the fluorine-based lubricant to cathode active material may be, for example, 0.4% by weight or more, 0.6% by weight or more, or 0.8% by weight or more. On the other hand, the ratio is, for example, 1.2 wt % or less, and may be 1.0 wt % or less. When the ratio of the fluorine-based lubricant is within the above range, the filling ratio can be improved while increasing the ratio of cathode active material in cathode mixture.

### 4. Cathode Mixture

Cathode mixture may further contain at least one of a conductive material and a binder in addition to the above-described compound cathode active material, the second sulfide solid electrolyte, and the fluorine-based lubricant.

Examples of the conductive material may include a carbon material, metal particles, conductive polymer. Carbon materials include, for example, particulate carbon materials such as acetylene black (AB) and Ketjen black (KB), and fibrous carbon materials such as carbon fibers, carbon nanotubes (CNT), and carbon nanofibers (CNF). Examples of the binder include a fluorinecontain binder such as polyvinylidene fluoride (PVDF), a rubber-based binder such as butadiene rubber, and an acrylic-based binder.

Cathode mixture may contain a dispersion medium for dispersing the above-described components. Examples of the dispersion medium include organic solvents such as butyl butyrate, dibutyl ether, heptane, and tetrahydrofuran.

Cathode mixture is typically used in cathode active material layers of all solid state battery. That is, in the present disclosure, it is also possible to provide a all solid state battery including a cathode active material layer, a anode active material layer, cathode active material layer, and a solid electrolyte layer disposed between anode active material layer, wherein cathode active material layer contains cathode mixture described above. Anode active material layers and solid electrolyte layers may be members known in the art in all solid state battery.

All solid state battery is typically an all-solid-state lithium-ion battery. Applications of all solid state battery include, for example, power supplies for vehicles such as hybrid electric vehicle (HEV), plug-in hybrid electric vehicle (PHEV), battery electric vehicle (BEV), gasoline-powered vehicles, diesel-powered vehicles, and the like. In particular, it is preferably used for a power supply for driving a hybrid electric vehicle (HEV), a plug-in hybrid electric vehicle (PHEV), or a battery electric vehicle (BEV). Battery may be used as a power source for a moving object (for example, a railroad, a ship, or an airplane) other than vehicles, or may be used as a power source for an electric appliance such as an information processing device.

Note that the present disclosure is not limited to the above-described embodiment. The above-described embodiment is an example, and any one having substantially the same configuration as the technical idea described in the claims in the present disclosure and having the same operation and effect is included in the technical scope of the present disclosure.

### EXAMPLES

### Example 1

### Preparation of Composite Cathode Active Material

A composite cathode active material having a first coating layer and a second coating layer as coating layer was prepared as follows.

10.8 parts by mass of metaphosphoric acid (manufactured by Fujifilm Wako Pure Chemical Industries, Ltd.) was dissolved in 166 parts by mass of ion-exchanged water. Lithium hydroxide monohydrate was added to the obtained solutions so that the molar ratio of Li element to the P element was 0.45. Thus, a coating liquid was prepared.

100 parts by weight of cathode active material (LiNi_{0.8}Co_{0.15}Al_{0.05}O₂) were dispersed in 53.8 parts by weight of the coating liquid. The resulting suspension was spray dried to give a powder. The obtained powder was heat-treated under conditions of 200° C. and 5 hours in an atmosphere. This resulted in a precursor active material having a cathode active material coated with an oxide solid electrolyte (Li₃PO₄).

Then, the precursor active material and sulfide solid electrolyte (sulfide solid electrolyte containing LiI in Li₂S—P₂S₅ system) were weighed so that the volume ratio of sulfide solid electrolyte (first coating layer) to the precursor active material was as shown in Table. 1. These were introduced into a dry kneading apparatus and kneaded. This resulted in a composite cathode active material having a solid electrolyte oxide layer (second coating layer) and a sulfide solid electrolyte layer (first coating layer).

### (Preparation of Cathode)

The composite cathode active material and the second sulfide solid electrolyte (Li₂S—P₂S₅ based glass ceramic containing LiI; D₅₀=0.8 μm) were weighed so that the ratio X/(X+Y) of X to the sum of the volume (X) of the precursor active material and the volume (Y) of the sum of the first coating layer and the second sulfide solid electrolyte was the ratio shown in Table 1. In Table 1, X/(X+Y) is expressed as AM, and Y/(X+Y) is expressed as SE. These were mixed with a conductive auxiliary agent (VGCF), a binder (butadiene rubber), and a fluorine-based lubricant (perfluoropolyether (PFPE)) in butyl butyrate. The amount of the fluorine-based lubricant was the amount of the ratio shown in Table 1 with respect to cathode active material. This gave a cathode mixture. Cathode mixture was sufficiently dispersed by an ultrasonic homogenizer (UH-50 manufactured by S.M.) and then coated on a cathode current collector (aluminum foil) and dried at 100° C. for 30 minutes. Thereafter, cathode having cathode active material layers and cathode current collector was obtained by punching to the size of 1 cm².

### (Production of Evaluation Battery)

To a kneading container of a fill-mix device (30-L type manufactured by Primix Co., Ltd.), sulfide solid electrolyte (Li₂S—P₂S₅ glass-ceramics containing LiI, D₅₀: 0.8 μm), 1% by weight of a conductive auxiliary agent (gas phase method carbon fiber: VGCF), a binder (2% by weight of butadiene rubber solution), and heptane were charged, and the mixture was 20000 rpm stirred for 30 minutes. Anode active material (Li₄Ti₅O₁₂ particles; D₅₀=1 micron) was then placed in a kneading container so that the volume ratio of anode active material to sulfide solid electrolyte was 7:3, and the mixture was 15000 rpm stirred for 60 minutes in a fill-mix device. This gave a anode mixture. Anode mixture was coated on a anode current collector (copper foil) and dried at 100° C. for 30 minutes. Anode with anode active material layers and anode current collector were then obtained by punching into 1 cm² sizes.

A sulfide solid electrolyte (Li₂S—P₂S₅ based glass ceramic containing LiI; D₅₀=2.5 μm) 64.8 mg was placed in a cylindrical ceramic having an inner diameter cross-sectional area 1 cm², smoothed, and then pressed with a 1 ton/cm² to form solid electrolyte layers.

Solid electrolyte layers were placed on one side of cathode active material and anode active material layers so that cathode and anode were placed on the other side of 6 ton/cm² and pressed for 1 minute. Stainless bars were then placed on both poles and constrained with 1 ton. As a result, an all-solid-state lithium-ion battery (evaluation-use battery) was obtained.

### Examples 2 to 5 and Comparative Examples 1 to 8

An all-solid-state lithium-ion battery was obtained in the same manner as in Example 1, except that the volume ratio of the first coating layer was changed to the values shown in Table 1 in the preparation of the complex cathode active material, and the ratio, AM and SE of the lubricant were changed to the values shown in Table 1 in the preparation of cathode.

### [Evaluation]

### (Evaluation of Resistance Increase Rate)

For battery, constant current-constant voltage charging and discharging were 2cyc performed at set voltage 2.8V, 1/3C rates and adjusted to SOC40% at 1/3C rates. The AC impedance was measured by 10 mV, 0.1˜106 Hz and the arc was fitted to Cole-Cole plot. The distance between two points of the intersection of the fitted arc and the real axis was defined as the interfacial resistance (resistance prior to cycling test). Next, the cycle test was performed at 60° C. and 1C, SOC0˜100%, 100cyc, and after the cycle test, the interfacial resistance (resistance after the cycle test) was measured again at the AC impedance. The resistivity increase rate before and after the cycle test was calculated. The resistance increase rate of each example and each comparative example was relatively evaluated using the increase rate of Example 1 as a reference (1.00). The results are shown in Table 1.

### (Evaluation of Filling Rate)

The weight and thickness of cathode active material layers after pressing were measured to calculate the density of cathode active material layers. The packing ratio was calculated from the ratio of cathode mixture to the theoretical density. The results are shown in Table 1.

TABLE 1

| | | First | | | | |
|---|---|---|---|---|---|---|
| | | coating | | | Filling | Resistance |
| | Lubricant | layer | AM | SE | rate | increase |
| | (wt %) | (vol %) | (vol %) | (vol %) | (%) | rate |
| Example 1 | 1.2 | 20 | 72 | 28 | 93.4 | 1.00 |
| Example 2 | 1.2 | 20 | 75 | 25 | 94.5 | 1.00 |
| Example 3 | 1.2 | 20 | 78 | 22 | 94.0 | 1.13 |
| Example 4 | 1.2 | 8 | 78 | 22 | 95.8 | 1.13 |
| Example 5 | 0.4 | 8 | 78 | 22 | 94.2 | 1.13 |
| Comp. | 0 | 20 | 72 | 28 | 89.9 | 0.87 |
| EX. 1 | | | | | | |
| Comp. | 0 | 20 | 75 | 25 | 89.6 | 0.87 |
| EX. 2 | | | | | | |
| Comp. | 0 | 20 | 78 | 22 | 89 | 0.93 |
| EX. 3 | | | | | | |
| Comp. | 1.2 | 0 | 72 | 28 | 93.4 | 1.13 |
| EX. 4 | | | | | | |
| Comp. | 1.2 | 0 | 75 | 25 | 92.1 | 1.20 |
| EX. 5 | | | | | | |
| Comp. | 1.2 | 0 | 78 | 22 | 92.4 | 1.33 |
| EX. 6 | | | | | | |
| Comp. | 1.2 | 20 | 80 | 20 | 94.4 | 1.47 |
| EX. 7 | | | | | | |
| Comp. | 1.2 | 0 | 80 | 20 | 93.6 | 1.53 |
| EX. 8 | | | | | | |

As shown in Table 1, in each of Examples 1 to 5, the filling ratio was good and the increase in the resistance increase rate could be suppressed. On the other hand, in Comparative Examples 1 to 8, at least one of the filling rate and the resistivity increase rate was inferior to that in the Example. From this, it was confirmed that when battery is used as the electrode mixture, battery can be improved and the resistivity can be suppressed from increasing. More specifically, in order to increase the energy-density of battery, it is assumed that the volume fraction of cathode active material in cathode mixture is increased. When the volume ratio of cathode active material is increased, it becomes difficult to increase the packing ratio because the grains of cathode active material interfere with each other. Therefore, by adding a fluorine-based lubricant as in Comparative Examples 4 to 6, the filling ratio can be improved, but when cathode active material and the fluorine-based lubricant are in direct contact with each other, battery resistivity increases due to the decomposition of the fluorine-based lubricant. On the other hand, as shown in Examples 1 to 5, by providing coating layer, it was possible to suppress an increase in battery resistivity while improving the packing ratio even when the predetermined volume ratio (AM) was increased to 72% by volume or more. Incidentally, as shown in Comparative Examples 1 to 3, even if coating layer was provided without using a fluorine-based lubricant, it was difficult to increase the packing ratio because the volume ratio of cathode active material was higher. Further, as shown in Comparative Examples 7 and 8, even when a fluorine-based lubricant was used, if AM was too high, it was difficult to suppress an increase in battery resistivity.

### REFERENCE SINGS LIST

1 Cathode active material
2 Coating layer
2A First coating layer
2B Second coating layer
10 Composite cathode active material

What is claimed is:

1. A cathode mixture comprising a composite cathode active material including a cathode active material, a first sulfide solid electrolyte and an oxide solid electrolyte, a second sulfide solid electrolyte and a fluorine-based lubricant, wherein
the composite cathode active material includes a coating layer covering at least a portion of a surface of the cathode active material and including the first sulfide solid electrolyte and the oxide solid electrolyte;
the coating layer includes a first coating layer including the first sulfide solid electrolyte, and a second coating layer arranged between the cathode active material and the first coating layer and including the oxide solid electrolyte;
the second sulfide solid electrolyte is not included in the coating layer; and
when the sum of a volume of the cathode active material and the second coating layer is X and the sum of a volume of the first coating layer and the second sulfide solid electrolyte is Y, a ratio of the X to the sum of the X and the Y(X/(X+Y)) is 72% by volume or more and 78% by volume or less.

2. The cathode mixture according to claim 1, wherein the fluorine-based lubricant is a perfluoropolyether.

3. The cathode mixture according to claim 1, wherein a ratio of the fluorine-based lubricant to cathode active material is 0.4 wt % or more and 1.2 wt % or less.

4. The cathode mixture according to claim 1, wherein when a volume of the first coating layer is Z, a ratio of the z to the X(Z/X) is 8% by volume or more and 20% by volume or less.

5. The cathode mixture according to claim 1, wherein a total thickness of the first coating layer and the second coating layer is 100 μm or less.
